(19) United States
(12) Patent Application Publication
(10) Pub. No.: US 2005/0060387 A1
(43) Pub. Date: Mar. 17, 2005

(54) Method of tripping blade server by running from a remote console

(75) Inventor: Chun-Liang Lee, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 10/644,844

(22) Filed: Aug. 21, 2003

(51) Int. Cl. G06F 15/177

(52) U.S. Cl. 709/220

(57) ABSTRACT

The present invention is to provide a method of remotely tripping one of a plurality of blade servers in a rack, each of the blade servers being coupled to a network switch which is in turn coupled to a computer system in a console which, when one of the blade servers is to be replaced, performs the steps of reading an input instruction of tripping a latch used for fastening each of the blade servers to the rack; sending the input instruction to the blade server via the network switch; and causing the blade server to trip the latch from the rack, enabling the management employee to quickly find the location of one blade server to be replaced by identifying each of the latch tripped from the rack in a crowded computer room.

### FIELD OF THE INVENTION

The present invention relates to server controls and more particularly to a method of tripping a malfunctioned blade server by running from a remote console for facilitating an employee to find the same for replacement or maintenance.

### BACKGROUND OF THE INVENTION

The world we are living in has entered into an electronics, information age with all sectors of industry developed prosperously. Currently, tower servers are widely used. But those skilled in the art have spent much money and time on developing a blade server as the progress of network technology continues. It is contemplated that blade servers will become the dominant type of server in a near future.

The blade server is a low cost server platform with high availability high density (HAHD). The blade servers have many applications including specific sectors (e.g., telecommunications, finance, Web host operations, etc.) and calculation intensive operations (e.g., data collection, digital image processing, etc.). The blade server is in fact a system board similar to an independent server. The blade servers are placed in compartments of a rack. Each system board operates in its own system for serving specified ones of user groups under this mode. In other words, there is no connection between any two system-boards. But they can use a common system software to form a server group consisting of these system boards. All system boards are adapted to couple together under the server group mode, thereby providing a high speed network environment, sharing resources, and serving the same user groups.

The conventional rack has advantages of saving space, reducing length of power cord, network cable, and keyboard cable, etc. Obviously, the rack has a disadvantage of occupying a large area in a computer room despite of the above advantages. As such, blade servers per unit area are increased. As a result, more server groups are installed in the computer room, i.e., higher server group density. Unfortunately, in a case of finding a malfunctioned blade server in the rack or disabling one blade server for replacement by a network management employee or maintenance technician, the network management employee or maintenance technician has to walk to the rack to find the blade server in a time consuming check procedure. Once the blade server is found, a new blade server can be mounted for replacement. This is a normal maintenance procedure for ensuring that the blade servers in the rack can operate normally. However, such procedure will significantly increase workload of the network management employee or maintenance technician in the crowded computer room having many racks installed therein. Moreover, it is not cost effective, labor intensive, and time consuming. Thus, the need for improvement still exists.

### SUMMARY OF THE INVENTION

A primary object of the present invention is to provide a method of enabling a network management employee or maintenance technician to quickly find one of a plurality of blade servers to be replaced by remotely tripping a latch coupled to each of the blade servers. By utilizing the present invention, the above drawbacks of the prior art can be overcome. These drawbacks are that in a case of finding a malfunctioned blade server for replacement, the network management employee or maintenance technician has to walk to the rack to find the blade server in a time consuming procedure. Moreover, it is not cost effective and labor intensive. The method of the present invention has the advantage of significantly reducing maintenance cost by eliminating the time consuming check procedure.

One object of the present invention is to provide a method of remotely tripping one of a plurality of blade servers in a rack, each of the blade servers being coupled to a network switch which is in turn coupled to a computer system in a console which, when detecting one of the blade servers is to be replaced and as commanded by a management employee, performs the steps of reading an input instruction of tripping a latch used to fasten each of the blade servers to the rack from the management employee; sending the input instruction to the blade server via the network switch; and causing the blade server to trip from the rack according to the input instruction. The method of the present invention also has the advantage of enabling the management employee to quickly find the location of one blade server to be replaced by remotely tripping the latch coupled to each of the blade servers in a crowded computer room. As such, the maintenance cost is significantly reduced by eliminating the time consuming check procedure as experienced in the prior art, thereby meeting the requirement in this fast growing electronics industry.

The above and other objects, features and advantages of the present invention will become apparent from the following detailed description taken with the accompanying drawings.

### BRIEF DESCRIPTION OF THE DRAWINGS

FIG. 1 schematically depicts the configuration of a preferred embodiment of the invention;

FIG. 2 is a block diagram of the components shown in FIG. 1; and

FIG. 3 is flow chart of the invention.

### DETAILED DESCRIPTION OF THE PREFERRED EMBODIMENTS

As stated above, the rack with a plurality of blade servers mounted therein has advantages of saving space, reducing length of power cord, network cable, and keyboard cable, etc. Thus, the racks have become the dominant product in server market. Unfortunately, in a case of finding a malfunctioned blade server in the rack or disabling one blade server for replacement by a network management employee or maintenance technician, the network management employee or maintenance technician has to walk to the rack to find the blade server. However, the maintenance procedure will significantly increase workload of the network management employee or maintenance technician in the crowded computer room. Moreover, it is not cost effective, labor intensive, and time consuming.

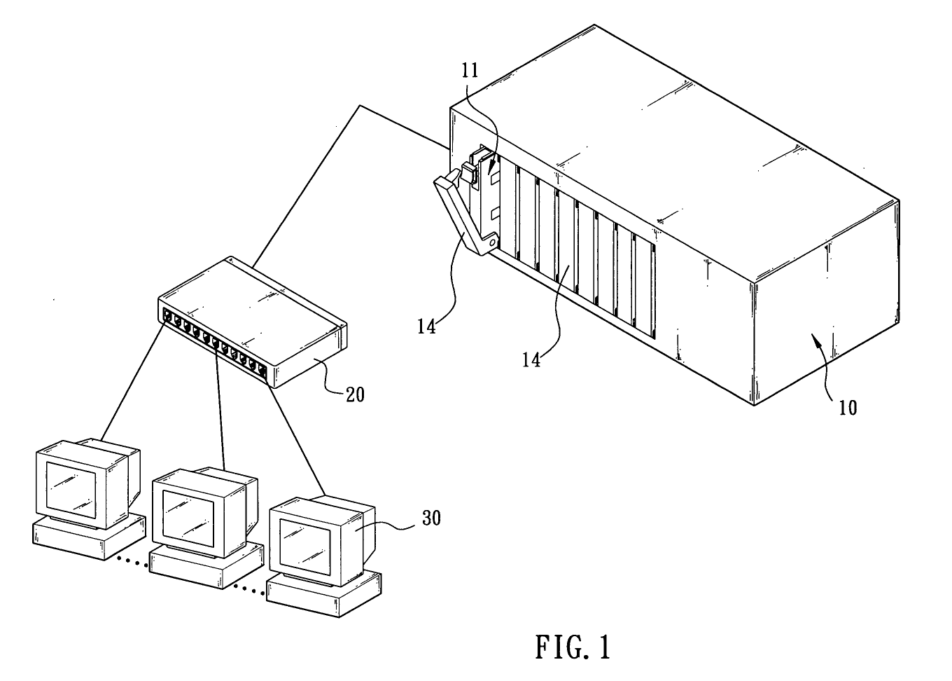

Referring to FIG. 1, there is shown a method of tripping a blade server by running from a remote console in accordance with the invention for overcoming the above drawback. The method comprises connecting each of a plurality of blade servers 11 mounted in a rack 10 to a network switch 20, and connecting the network switch 20 to the computer system in a console 30. As such, the network management employee or maintenance technician can issue an instruction from the computer system in the console 30. The instruction is then sent to one of the remote blade servers 11 for control via the network switch 20. As a result, a hinged latch 14 for fastening the blade server 11 in the rack 10 will be tripped. Hence, the network management employee or maintenance technician can quickly find the location of the desired blade server 11 for replacement or maintenance by visually observing the released latch 14.

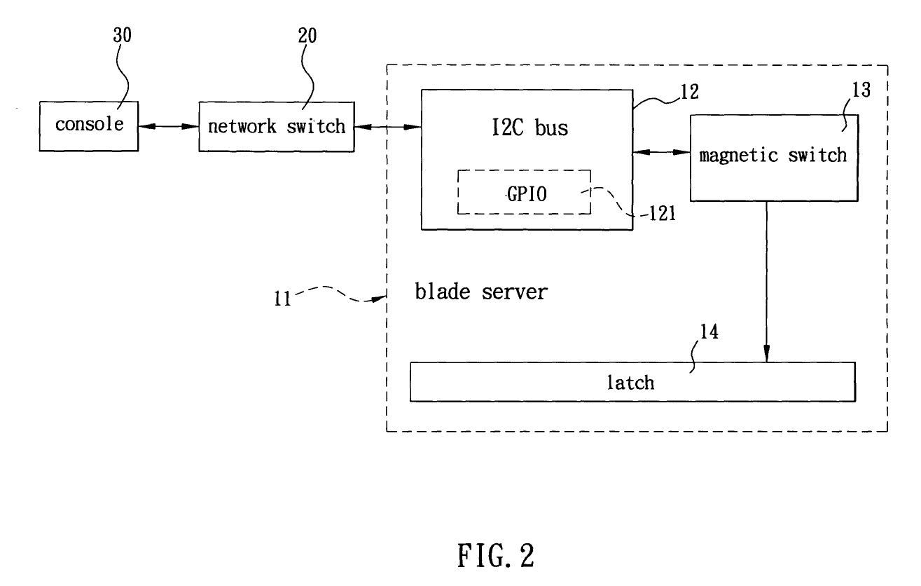

Referring to FIG. 2, in the invention each blade server 11 comprises an I2C (Inter-integrated Circuit) bus 12 and a magnetic switch 13 coupled to the I2C bus 12. The I2C bus 12 comprises a GPIO (General Purpose Input and Output) 121 for coupling to an external device as detailed later. The magnetic switch 13 is adapted to control the latch 14 hingedly coupled to the blade server 11 for tripping it if such is desired (see FIG. 1).

Also, a loop consisting of the computer system in the console 30, the network switch 20, and the GPIO 121 of the I2C bus 12 is formed. As such, the computer system in the console 30 can be coupled to the I2C bus 12 by coupling a serial (e.g., COM) port of the network switch 20 to the GPIO 121 of the I2C bus 12 for detecting and controlling the blade servers 11. The COM port is employed to communicate data or for facsimile purpose by the computer system in the console 30.

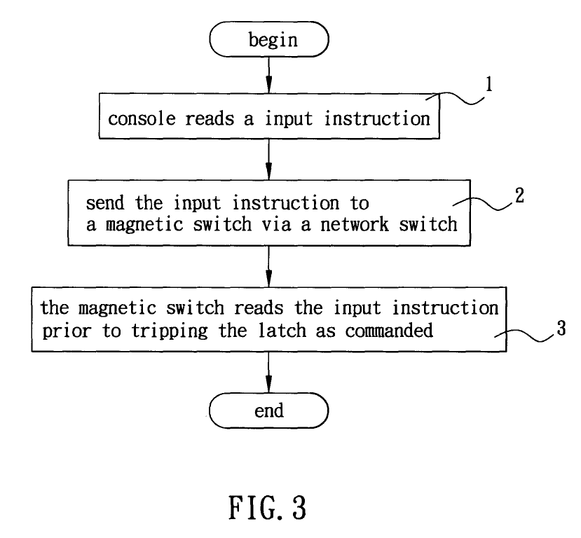

Referring to FIG. 3, in the invention in a case of replacing one of the blade servers 11 in the rack 10, the computer system in the console 30 will perform operations as commanded by the network management employee or maintenance technician:

In step 1, the console 30 first reads an input instruction of tripping the latch 14 coupled to the blade server 11 from the rack 10 inputted by the network management employee or maintenance technician.

In step 2, send the input instruction to the I2C bus 12 and the magnetic switch 13 via the network switch 20 and the coupled COM port and the GPIO 121.

In step 3, the magnetic switch 13 reads the input instruction. Next, the magnetic switch 13 causes the latch 14 coupled to the blade server 11 to trip as commanded by the input instruction. The process ends normally.

In brief, the invention enables the network management employee or maintenance technician to trip the latch 14 used to fasten the blade server 11 to the rack 10 by running from the remote console 30. Once the latch 14 is tripped, the network management employee or maintenance technician is able to quickly find the location of the blade server 11 for facilitation of replacement or maintenance by visually observing the released latch 14. This can overcome the prior drawback of requiring the network management employee or maintenance technician to walk to the rack 10 to find the blade server 11 in a time consuming check procedure. As a result, maintenance cost is greatly reduced.

While the invention has been described by means of specific embodiments, numerous modifications and variations could be made thereto by those skilled in the art without departing from the scope and spirit of the invention set forth in the claims.

1. A method of remotely tripping one of a plurality of blade servers in a rack, each of the blade servers being coupled to a network switch which is in turn coupled to a computer system in a console which, when detecting one of the blade servers is to be replaced and as commanded by a management employee, performs the steps of:
reading an input instruction of tripping a latch used to fasten each of the blade servers to the rack from the management employee;
sending the input instruction to the blade server via the network switch; and
causing the blade server to trip the latch from the rack according to the input instruction.

2. The method of claim 1, wherein each of the blade servers comprises an I2C (Inter-Integrated Circuit) bus including a GPIO (General Purpose Input and Output) for coupling to an external device, and a magnetic switch coupled to the I2C bus, the magnetic switch being adapted to control and trip the latch coupled to the blade server.

3. The method of claim 2, further comprising a loop consisting of the computer system in the console, the network switch, and the GPIO of the I2C bus so that the computer system in the console can be coupled to the I2C bus by coupling a serial port of the network switch to the GPIO of the I2C bus for detecting and controlling the blade servers.

4. The method of claim 3, wherein the input instruction is sent to the I2C bus and the magnetic switch via the network switch and the coupled serial port and the GPIO, and in response to reading the input instruction by the magnetic switch, the magnetic switch causes the latch coupled to the blade server to trip as commanded by the input instruction.
